(19) United States
(12) Patent Application Publication
(10) Pub. No.: US 2003/0189473 A1
(43) Pub. Date: Oct. 9, 2003

(54) AC electromagnet

(75) Inventors: Volker Lang, Bonn (DE); Rudolf Scholz, St. Augustin (DE)

Correspondence Address: DAVIDSON, DAVIDSON & KAPPEL, LLC, 485 SEVENTH AVENUE, 14TH FLOOR, NEW YORK, NY, 10018, US

(73) Assignee: MOELLER GMBH, Bonn (DE)

(21) Appl. No.: 10/407,108

(22) Filed: Apr. 4, 2003

(30) Foreign Application Priority Data
Apr. 5, 2002 (DE) 102 14 992.5

(51) Int. Cl. H01H 67/02

(52) U.S. Cl. 335/132

(57) ABSTRACT

An AC electromagnet for use in electric switchgear includes a fixed, U-shaped magnet core positioned symmetrically to a central plane and a movable armature that is guided during its translational stroke by guide devices. The armature is T-shaped and positioned symmetrically to the magnet core, and has a cross leg to close the magnetic circuit and a central leg, the central leg being oriented toward the central web of the magnet core. An air gap is formed between the free end of the central leg and the center of the central web transversally to the longitudinal axis of the central leg. Leg heads are formed on the lateral legs of the magnet core, enlarged with respect to the cross-section of the lateral legs. The internal profile formed by the magnet core and the enlarged leg heads has a square or rectangular design, into which the driving coil is insertable, and the driving coil fills the yoke profile almost completely.

This application claims priority to German Patent Application No. 102 14 992.5, which is hereby incorporated by reference herein.

The present invention relates to an AC electromagnet for use in an electric switchgear or as an AC magnet drive.

### BACKGROUND

AC electromagnets having a U-shaped magnetic core have two pairs of pole faces and two working air gaps. In AC magnets having E-shaped magnet parts, two pairs of pole faces and two working air gaps are formed on the lateral legs and a working air gap, which simultaneously acts as a remanent air gap (see European Patent Application 5734 A1) is formed on the central leg to prevent the armature from adhering to the switching magnet.

The force flux between the pairs of pole faces is determined by the surface of the leg heads forming the air gap. It is only possible to modify, in particular to increase, the surfaces by increasing the leg cross-sections, which in turn affects the overall volume of the driving coil. The opposite effects of the above-mentioned features prevent such an AC electromagnet from having an optimum and energy-efficient design.

### SUMMARY OF THE INVENTION

An object of the present invention is therefore to provide an AC magnet device which either provides a reduced pick-up power for the same material use or permits a reduction in material use while preserving the pick-up power.

The present invention provides an AC electromagnet device made of sheet metal magnet parts for use in an electric switchgear, in a contactor in particular, or as an AC magnet drive via a driving coil (330), including a fixed, U-shaped magnet core (10) positioned symmetrically to a central plane (M) and a movable armature (60) which is guided during its translational stroke by guide devices (40). The armature is T-shaped and positioned symmetrically to the magnet core (10), and has a cross leg (62) to close the magnetic circuit and a central leg (66), the central leg (66) being oriented toward the central web (12) of the magnet core (10). An air gap (22) is formed between the free end (64) of the central leg (66) and the center of the central web (12) transversally to the longitudinal axis of the central leg (66). Leg heads (14) are formed on the lateral legs (11) of the magnet core (10), enlarged with respect to the cross-section of the lateral legs (11), at least one short-circuit ring (42) being insertable into the leg heads. The internal profile (300) formed by the magnet core (10) and the enlarged leg heads (14) has a square or rectangular design, into which the driving coil (330) is insertable, and the driving coil (330) fills the yoke profile (300) almost completely.

Thus an AC electromagnet device is provided, the device being made of sheet metal magnet parts for use in an electric switchgear, in a magnetic contactor in particular or as an AC magnet drive via a driving coil having excitation winding in a bobbin, the device:

having a fixed, U-shaped magnet core, positioned symmetrically to a central plane and designed in a single piece;

having a movable, T-shaped armature positioned symmetrically to the magnet core, which is guided during its translational stroke by guide devices and is formed by a cross leg and a central leg, the latter being oriented toward the center of the central web of the magnet core;

having an air gap formed between the free end of the central leg and the center of the central web, essentially transversally to the longitudinal axis of the central leg, the air gap being formed by flat air gap faces, which run perpendicularly to the longitudinal axis of the central leg; and

having leg heads on the lateral legs of the magnet core, enlarged with respect to the cross-section of the lateral legs, at least one short-circuit ring being insertable into the leg heads;

the internal or yoke profile formed by the magnet core and the enlarged leg heads having a square or rectangular design, into which the driving coil, including the bobbin, is insertable in the direction of the central plane, i.e., perpendicularly to the main plane of the magnet core, and the driving coil fills it almost completely.

A large amount of free space is created for the insertion and assembly of the driving coil. The design of the working air gap of the central leg is adjusted to this requirement in that the entire surface of the central web facing the magnet armature is in a plane that has no material formations or elevations protruding into the internal profile that could impede the insertion of the driving coil. The internal or yoke profile is formed by the internal surfaces of the lateral legs of the magnet core, the internal surfaces of the leg heads, and the internal surface of the central web of the magnet core.

In the ON position of the switchgear, the air gap of the central leg acts as a remanent air gap.

Embodiments of the present invention may differ in the design and position of the air gap faces of the central leg.

The faces of the air gap on the central leg may be designed parallel to the axis of the central web of the magnet armature or at an angle to the axis of the central web. Preferably a symmetrical wedge shape is proposed. The wedge shape of the air gap is designed so that the wedge is perpendicular to the longitudinal axis of the central leg and is oriented toward the central web. The matching shape of the air gap faces on the central web is a wedge-shaped recess.

In an embodiment, the yoke profile has a rectangular or square design.

In an embodiment, the surface of the central web facing the yoke profile is designed without elevations protruding into the yoke profile.

In an embodiment, a wedge-shaped recess is formed as a magnet yoke-side face of the working air gap in the face of the central web facing the yoke profile.

In an embodiment, the pole faces (of the working air space) between the magnet core and armature are ground flat.

An advantage of the device according to the present invention is that the surface of the pole face pairs is enlarged due to the special design of the leg heads even for a relatively small or relatively unchanged lateral leg cross-section. Thus the magnetic resistance is reduced when magnetic circuit is open (i.e., in the OFF contactor position). The pick-up power to be applied in this position electrically by the transformer is reduced. The mass of the cross leg which loses the magnetic circuit and thus the moment of inertia of the movable magnet armature may be reduced, and thereby kinetically matched to the contact apparatus.

### DESCRIPTION OF THE DRAWINGS

The present invention is elaborated upon below based on exemplary embodiments with reference to the drawings.

FIG. 1 shows a perspective view of an AC electromagnet device according to a first embodiment of the present invention having a remanent air gap with flat surfaces.

FIG. 2 shows a perspective view of an AC electromagnet device according to a second embodiment of the present invention having a wedge-shaped remanent air gap.

FIG. 3 shows a schematic front view according to FIG. 2.

FIG. 4 shows a schematic front view of an AC electromagnet device according to a third embodiment of the present invention.

### DETAILED DESCRIPTION

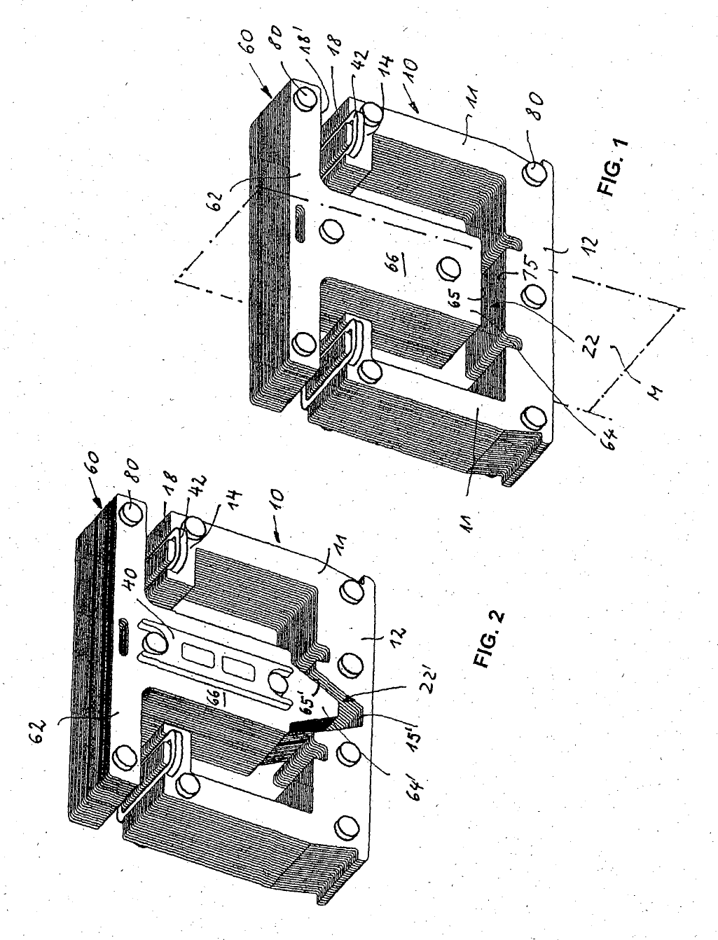

In the embodiments according to FIGS. 1 through 4, the magnet components (yoke 10 and armature 60) of the magnet device are made of stamped core stacks and have a rectangular cross-section. The stacks are riveted (rivets 80), but may also be welded, which results in mechanical adhesion.

Fixed magnet core 10 is situated in a housing (not shown) and has two lateral legs 11 that are oriented parallel to one another and are connected by a central web 12. At the ends of lateral legs 11, leg heads 14 having enlarged pole faces 18 form the working air gap and each one carries one short-circuit ring 42. Leg heads 14 have significantly enlarged pole faces 18 compared to the cross-section of lateral legs 11. The leg heads project toward central leg 66 of the magnet armature, the distance to the central leg being kept somewhat greater than the distance between the pole faces in the raised state. Both pole faces 18 are in a spatial plane formed by the flat ground surface. Pole faces 18′ on magnet armature 60, associated with pole faces 18 of the lateral legs, are also ground flat.

Magnet armature 60 has a T-shaped design; its cross leg 62 is able to close the magnetic circuit of the magnet device, and its central leg 66 is oriented toward the center of central web 12 of the magnet core.

At least one spring (not illustrated) applies a restoring force to magnet armature 60, which is linearly movable. Central leg 66 is surrounded by a driving coil having a bobbin and an excitation winding (see FIG. 4). The magnet device is complemented by a driving coil 330, which almost completely fills the space between central web 12, lateral legs 11, and leg heads 14 and inside which armature 60 is moved toward central web 12 of the magnet core. The magnet armature has an appropriate stroke in the working air gap. A mechanical linkage between the magnet armature and a contact apparatus of the switch or contactor is not illustrated.

The magnet device has a symmetric design with respect to a vertical plane of symmetry M.

Yoke profile (cavity) 300 delimited by central web 12, lateral webs 11, and leg heads 14 of magnet core 10 has a square or rectangular shape. The cross-section formed by the yoke profile permits driving coil 330, including the bobbin, to be easily inserted and attached perpendicularly to the plane of symmetry of the magnet core.

In order to ensure the desired large free space for the driving coil, the air gap on the internal leg is designed so that the entire surface of central web 12 facing the magnet armature is in a plane which has no elevations (material formations) protruding into yoke profile 300.

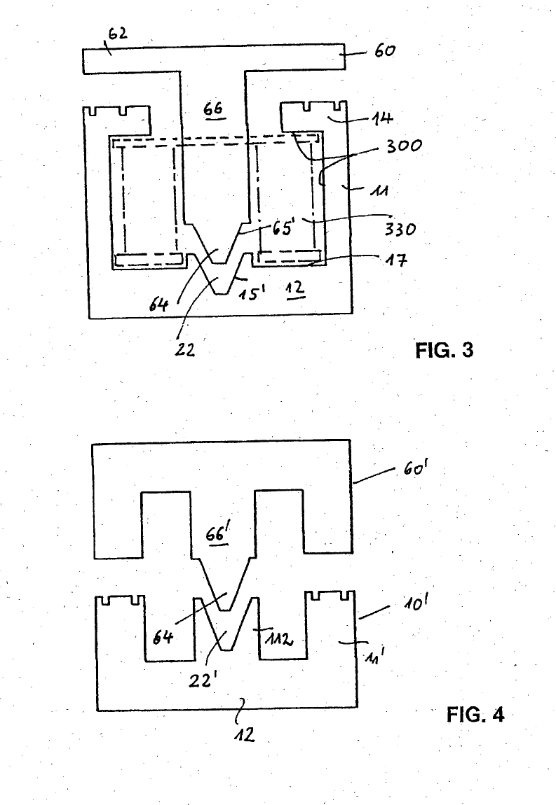

The two embodiments shown in FIGS. 2 and 3 differ from one another in the shape of air gaps 22, 22′. In the second embodiment, the yoke profile has the same free space as that of the first embodiment. The effective cross-section of the air gap on the internal leg is, however, enlarged due to its angled shape. According to FIGS. 2, 3, and 4, air gap 22′ may have a edge-shaped or triangular-shaped design.

The tolerance of the guide elements in the housing and/or within the bobbin of the embodiment according to FIG. 1 may be greater than in the variant of FIG. 2. In the embodiment according to FIG. 2, additional measures must be taken, for example, additional plastic guides, to comply with the required narrow tolerance of the movement guidance.

FIG. 3 schematically shows the front view according to FIG. 2 to illustrate internal profile 300 and indicate bobbin 330. To form a particularly large surface of the working air gap, the cross-section of leg heads 14 is larger than the cross-section of the lateral legs. Grooves into which a short-circuit ring may be inserted are formed in leg heads 14.

FIG. 4 shows a magnet device having essentially E-shaped magnet parts 60′ and 10′. Lower body 10′ may be understood to be a fixed magnet core and upper body 60′ may be understood to be a movable armature. The air gap (and remanent air gap for the ON position of the switch) at the central part of the E-shaped body has a wedge-shaped design, as can also be seen in FIGS. 2 and 3. Formation 112 protruding into yoke profile 300, in which the appropriate recess is formed for the wedge shape of the pole faces, is situated on the central web of the magnet armature.

What is claimed is:

1. An AC electromagnet device for use in an electric switchgear, the device comprising:
a U-shaped fixed magnet core disposed symmetrically to a central plane and including a central web and a first and a second lateral leg, the lateral legs each including a respective leg head, each respective leg head being larger than a cross-section of the respective lateral leg and being configured to receive at least one respective short-circuit ring therein, an internal yoke profile defined by the magnet core having a square or rectangular shape configured for receiving a driving coil so that the driving coil nearly fills the yoke profile; and
a T-shaped movable armature configured to be guided during a translational stroke by a guide device, the armature being disposed symmetrically to the magnet core and including a cross leg configured to close a magnetic circuit and including a central leg, the central leg being oriented toward the central web and having a free end so as to form an air gap with a center of the central web.

2. The AC electromagnet device as recited in claim 1 wherein at least one of the fixed magnet core and the movable armature includes a sheet metal magnet part.

3. The AC electromagnet device as recited in claim 1 wherein the electric switchgear includes a contactor having a driving coil.

4. The AC electromagnet device as recited in claim 1 wherein the electric switchgear includes an AC magnet drive having a driving coil.

5. The AC electromagnet device as recited in claim 1 wherein the air gap is defined by a surface of the central leg, the surface being parallel to an axis of the central web.

6. The AC electromagnet device as recited in claim 1 wherein the air gap is defined by at least one surface of the central leg, the surface being at an angle to an axis of the central web.

7. The AC electromagnet device as recited in claim 6 wherein the at least one surface is disposed in a wedge shape.

8. The AC electromagnet device as recited in claim 7 wherein the wedge shape is oriented toward the central web.

9. The AC electromagnet device as recited in claim 7 wherein the central web defines a wedge-shaped recess.

10. The AC electromagnet device as recited in claim 1 wherein a surface of the central web facing the yoke profile has no elevations protruding into the yoke profile.

11. The AC electromagnet device as recited in claim 1 wherein a respective first face of each respective leg head forms a working air gap with an opposite respective second face of the movable armature, the first and second faces being flat.

12. The AC electromagnet device as recited in claim 11 wherein the first and second faces are ground flat.
